(19) United States
(12) Patent Application Publication
(10) Pub. No.: US 2025/0383070 A1
(43) Pub. Date: Dec. 18, 2025

(54) HALOGEN LAMP

(71) Applicant: RarEarth Tech Co., Ltd., New Taipei City (TW)

(72) Inventors: Wan-Yu HSUEH, Taipei City (TW); Ia-Shian BAI, Zhubei City (TW); Yu-Chen CHENG, Zhubei City (TW)

(73) Assignee: RarEarth Tech Co., Ltd., New Taipei City (TW)

(21) Appl. No.: 19/195,383

(22) Filed: Apr. 30, 2025

(30) Foreign Application Priority Data
Jun. 14, 2024 (TW) 113122219

(51) Int. Cl. F21V 19/06; H01K 1/14; H01K 1/18

(52) U.S. Cl. CPC F21V 19/06; H01K 1/14; H01K 1/18

(57) ABSTRACT

The invention provides a halogen lamp, including: a socket, a transparent shell, two conductive members, a spiral filament, two insulating rods and a supporting mechanism. The supporting mechanism includes a front and a rear supporting portion. Several front hooks of the front supporting portion are respectively connected between the spiral filament and a front supporting rod of the front supporting portion, several rear hooks of the rear supporting portion are respectively connected between the spiral filament and a rear supporting rod of the rear supporting portion, and the front supporting portion and the rear supporting portion are arranged in a symmetric pattern. Therefore, the spiral filament can be fixed by the supporting mechanism without easy deviating, thereby increasing the service life of the halogen lamp.

### FIELD OF THE INVENTION

The present invention relates to a halogen lamp, and in particular to a halogen lamp with a supporting mechanism that is arranged symmetrically so that a spiral filament in the halogen lamp is not easy to deviate, and the service life of the halogen lamp can be relatively improved.

### BACKGROUND OF THE INVENTION

A halogen lamp is a common incandescent lamp. A manufacturing principle of the halogen lamp is to inject a halogen element gas such as iodine, bromine or the like into a bulb. When the halogen lamp is turned on, a tungsten filament in the bulb will gradually be heated to generate a high temperature, making the halogen lamp glow and generate heat. At this time, the tungsten atoms on the tungsten filament will be evaporated, so that the tungsten atoms diffuse and move to a lower-temperature inner wall of the bulb, thereby allowing the cooled tungsten to bind with the halogen element gas to generate tungsten halide. The tungsten halide is driven by an airflow in the bulb to move to a high temperature area near the tungsten filament, so that the tungsten halide is decomposed into tungsten atoms and halogen atoms, and the tungsten atoms will then settle on the tungsten filament to make up for the evaporated tungsten atoms. Thereby, this continuous cycle prolongs the service life of the halogen lamp, and meanwhile the tungsten filament can operate normally at a high temperature.

However, during the use of the halogen lamp, the tungsten filament in the halogen lamp often falls off, displaces or breaks due to shaking, impact, thermal expansion and contraction, and the like, and thus cannot be used continually. Therefore, it is one of the important technologies to fix the tungsten filament in the bulb stably.

### SUMMARY OF THE INVENTION

A main objective of the present invention is to improve a structural pattern of a halogen lamp, so that the halogen lamp has a plurality of front supporting rods and a plurality of front hooks to form a symmetrical pattern with a plurality of rear supporting rods and a plurality of rear hooks, and a supporting mechanism and a first conductive member are respectively located on two opposite sides of a spiral filament to fix the spiral filament, thereby avoiding the position of the spiral filament from being offset, and relatively maintaining the structure stability of the halogen lamp, while extending the service life of the halogen lamp.

To achieve the aforementioned objective, the present invention relates to a halogen lamp, which has a socket, a transparent shell, a first conductive member, a second conductive member, a spiral filament, a first insulating rod, a second insulating rod and a supporting mechanism. The socket has a plug-in end and a fixed end. The fixed end has a first conductive plate, a second conductive plate and a mounting portion.

The transparent shell has a closed end and an open end. The closed end is provided with a connecting portion, and the open end is connected to the mounting portion of the socket, so that an enclosed space is formed between the closed end and the fixed end of the socket, where the connecting portion is configured as a groove, and a first end of the first conductive member passes through the second insulating rod to connect the groove, and a second end of the first conductive member passes through the first insulating rod to connect the first conductive plate, so that the first conductive member is fixed between the groove and the first conductive plate.

The first conductive member is connected between the connecting portion and the first conductive plate, and the second conductive member is connected to the second conductive plate. However, the spiral filament has a spiral section and two lead sections located on two opposite sides of the spiral section. One of the lead sections is connected to the first conductive member, and the other of the lead sections is connected to the second conductive member.

However, the first insulating rod is connected to the first conductive member and the second conductive member, and the first insulating rod is far away from the closed end, and the second insulating rod is connected to the first conductive member, and the second insulating rod is adjacent to the closed end.

In a first preferred embodiment, the supporting mechanism is disposed between the first insulating rod and the second insulating rod, and the supporting mechanism and the first conductive member are respectively located on two opposite sides of the spiral filament. The supporting mechanism includes a front supporting portion and a rear supporting portion. The front supporting portion includes a plurality of front supporting rods and a plurality of front hooks. The front hooks are respectively connected between the spiral filament and one of the front supporting rods. The rear supporting portion includes a plurality of rear supporting rods and a plurality of rear hooks. The rear hooks are respectively connected between the spiral filament and one of the rear supporting rods.

The front hook has a first surrounding portion, a first ring portion, and a first extension portion connected between the first surrounding portion and the first ring portion. The first surrounding portion is coiled around the front supporting rod, and the first ring portion is encircled around the spiral filament, so that the front hook and the first conductive member are respectively located on two opposite sides of the spiral filament. The rear hook has a second surrounding portion, a second ring portion, and a second extension portion connected between the second surrounding portion and the second ring portion. The second surrounding portion is coiled around the rear supporting rod, and the second ring portion is encircled around the spiral filament, so that the rear hook and the first conductive member are respectively located on two opposite sides of the spiral filament.

However, the amount of the front supporting rods are the same that of the rear supporting rods, the amount of the front hooks are the same that of the rear hooks, and the mounting direction of the front hooks is opposite to that of the rear hooks, so that the front supporting portion and the rear supporting portion are arranged to form a symmetrical pattern.

Moreover, the halogen lamp further has a fixing member the first conductive member and the second insulating rod, so that the fixing member and the supporting mechanism are respectively located on two opposite sides of the spiral filament.

In a second preferred embodiment, the halogen lamp includes the socket, the transparent shell, the first conductive member, the second conductive member, the spiral filament, the first insulating rod, the second insulating rod and the supporting mechanism. The socket has the plug-in end and the fixed end. The fixed end has the first conductive plate, the second conductive plate and the mounting portion. The transparent shell has the closed end and the open end. The closed end is provided with the connecting portion, and the open end is connected to the mounting portion of the socket, so that the enclosed space is formed between the closed end and the fixed end of the socket.

The first conductive member is connected between the connecting portion and the first conductive plate, the second conductive member is connected to the second conductive plate, and the spiral filament has the spiral section and two lead segments located on two opposite sides of the spiral section. One of the lead segments is connected to the first conductive member, and the other of the lead segments is connected to the second conductive member.

However, the first insulating rod is connected to the first conductive member and the second conductive member, and the first insulating rod is far away from the closed end, and the second insulating rod is connected to the first conductive member, and the second insulating rod is adjacent to the closed end.

In a second preferred embodiment, the supporting mechanism is disposed between the first insulating rod and the second insulating rod, and the supporting mechanism and the first conductive member are located on two opposite sides of the spiral filament, respectively. The supporting mechanism includes the front supporting portion and the rear supporting portion. The front supporting portion includes the front supporting rod and the front hooks connected between the front supporting rod and the spiral filament. The rear supporting part includes the rear supporting rod and the rear hooks connected between the rear supporting rod and the spiral filament, where the amount of the front hooks are the same that of the rear hooks, and the mounting direction of the front hooks is opposite to that of the rear hooks, so that the front supporting portion and the rear supporting portion are arranged to form the symmetrical pattern.

The present invention is characterized in that the supporting mechanism of the halogen lamp has a front supporting portion and a rear supporting portion. The front supporting portion includes a plurality of front supporting rods and a plurality of front hooks. The front hooks are respectively connected between the spiral filament and one of the front supporting rods. The rear supporting portion includes a plurality of rear supporting rods and a plurality of rear hooks. The rear hooks are respectively connected between the spiral filament and one of the rear supporting rods, where the amount of the front supporting rods are the same that of the rear supporting rods, the amount of the front hooks are the same that of the rear hooks, and the mounting direction of the front hooks is opposite to that of the rear hooks, so that the front supporting portion and the rear supporting portion are arranged to form a symmetrical pattern. The supporting mechanism and the first conductive member are respectively located on two opposite sides of the spiral filament, and the first conductive member is connected to the spiral filament, so that the spiral filament is fixed between the supporting mechanism and the first conductive member, thereby avoiding the position of the spiral filament from being offset, relatively maintaining the structure stability of the halogen lamp and extending the service life of the halogen lamp.

### BRIEF DESCRIPTION OF THE DRAWINGS

FIG. 1 is a schematic diagram of a halogen lamp of the present invention in a first preferred embodiment; and

FIG. 2 is a schematic diagram of a halogen lamp of the present invention in a second preferred embodiment.

### DETAILED DESCRIPTION OF THE PREFERRED EMBODIMENTS

In order to have further clear and detailed knowledge and understanding of the construction, use and features of the invention, preferred embodiments are given and described in detail with reference to the drawings as follows:

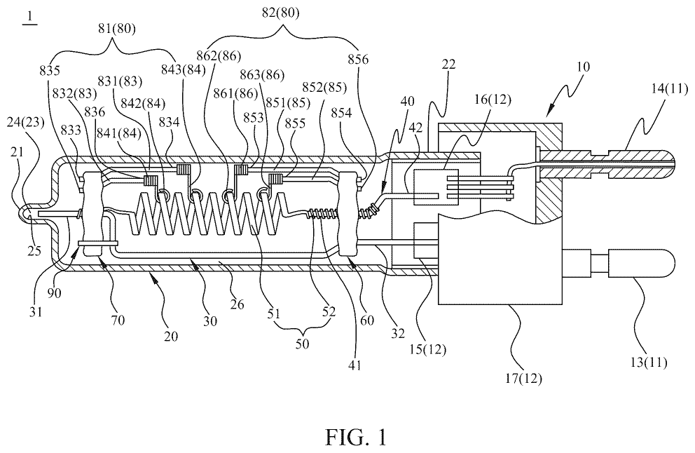

Referring to FIG. 1, in a first preferred embodiment, a halogen lamp 1 of the present invention is mainly composed of a socket 10, a transparent shell 20, a first conductive member 30, a second conductive member 40, a spiral filament 50, a first insulating rod 60, a second insulating rod 70, a supporting mechanism 80 and a fixing member 90. The socket 10 has a plug-in end 11 and a fixed end 12. The plug-in end 11 has a first lamp pin 13 and a second lamp pin 14. The fixed end 12 has a first conductive plate 15, a second conductive plate 16 and a mounting portion 17. The first lamp pin 13 and the first conductive plate 15 are respectively located on two opposite sides of the mounting portion 17, and the second lamp pin 14 and the second conductive plate 16 are respectively located on two opposite sides of the mounting portion 17.

Referring to FIG. 1, in the first preferred embodiment, the transparent shell 20 is made of a glass material. The transparent shell 20 has a closed end 21 and an open end 22 at two opposite ends thereof respectively. The closed end 21 is provided with a connecting portion 23. In the first preferred embodiment, the connecting portion 23 is configured as a groove 24. The groove 24 forms an accommodation space 25 in the interior of the transparent shell 20, and the open end 22 is connected to the mounting portion 17 of the socket 10, so that an enclosed space 26 is formed between the closed end 21 and the fixed end 12 of the socket 10, in turn the first conductive plate 15 and the second conductive plate 16 are co-positioned in the enclosed space 26, and the enclosed space 26 is communicated with the accommodation space 25, so that the first conductive plate 15 and the second conductive plate 16 are respectively arranged at two opposite sides of the enclosed space 26 with the groove 24, where in the first preferred embodiment, the volume of the enclosed space 26 is greater than that of the accommodation space 25. Moreover, the enclosed space 26 is filled with a halogen element gas, and the halogen element gas can be iodine or bromine.

Referring to FIG. 1, in the first preferred embodiment, the first conductive member 30 has a first conductive end 31 and a second conductive end 32 at two opposite ends thereof, where the first conductive end 31 is inserted into the accommodation space 25 of the groove 24 is adjacent to the closed end 21, and the second conductive end 32 is connected to the first conductive plate 15 is adjacent to the open end 22, so that the first conductive member 30 is connected between the connecting portion 23 and the first conductive plate 15. Moreover, the second conductive member 40 has a third conductive end 41 and a fourth conductive end 42 at two opposite ends thereof, respectively. The fourth conductive end 42 is connected to the second conductive plate 16 is adjacent to the open end 22, so that the second conductive member 40 is connected to the second conductive plate 16. However, in this embodiment, the length of the first conductive member 30 is greater than that of the second conductive member 40.

As shown in FIG. 1, in the first preferred embodiment, the spiral filament 50 has a spiral section 51 and two lead sections 52 being connected to the spiral section 51, and the lead sections 52 are located at opposite left and right sides of the spiral section 51, where one of the lead sections 52 is wound around the first conductive end 31 of the first conductive member 30, so that one of the lead sections 52 is connected to the first conductive member 30, and the other of the lead sections 52 is wound around the third conductive end 41 of the second conductive member 40, and thus the other of the lead sections 52 is connected to the second conductive member 40, thereby connecting the spiral section 51 between the first conductive member 30 and the second conductive member 40.

Referring to FIG. 1, in the first preferred embodiment, the first insulating rod 60 has a plurality of first openings for inserting the second conductive end 32 of the first conductive member 30 and the third conductive end 41 of the second conductive member 40, and the second insulating rod 70 has a plurality of second openings for inserting the first conductive end 31 of the first conductive member 30, so that partial of the lead segment 52 wrapped around the second conductive member 40 is positioned in the first opening, and in turn the first insulating rod 60 is connected to the first conductive member 30 and the second conductive member 40, and the first insulating rod 60 is adjacent to the open end 22 and the first insulating rod is far away from the closed end 21. Meanwhile, partial of the lead segment 52 wrapped around the first conductive member 30 is positioned in the second opening, and in turn the second insulating rod 70 is connected to the first conductive member 30, and at the same time the second insulating rod 70 is adjacent to the closed end 21 and the first insulating rod is far away from the open end 22. Thereby, the first conductive end 31 of the first conductive member 30 passes through the second insulating rod 70 is connected with the groove 24, and the second conductive end 32 of the first conductive member 30 passes through the first insulating rod 60 is connected with the first conductive plate 15, and in turn the first conductive member 30 is fixed between the groove 24 and the first conductive plate 15. Furthermore, the composition material and structural pattern of the first insulating rod 60 and the second insulating rod 70 are not limited. The composition material of the first insulating rod 60 and the second insulating rod 70 can be quartz, and the structural pattern of the first insulating rod 60 and the second insulating rod 70 can be any structural pattern.

Referring to FIG. 1, in the first preferred embodiment, the supporting mechanism 80 includes a front supporting portion 81 and a rear supporting portion 82. The front supporting portion 81 includes a plurality of front supporting rods 83 and a plurality of front hooks 84, where the front supporting rods 83 have a first front supporting rod 831 and a second front supporting rod 832 parallel to the first front supporting rod 831, the first front supporting rod 831 has a first front end 833 and a first rear end 834 at two opposite ends thereof respectively, and the first front end 833 of the first front supporting rod 831 is inserted into the second opening of the second insulating rod 70, so that the first front supporting rod 831 is connected to the second insulating rod 70 near the closed end 21. However, the second front supporting rod 832 has a second front end 835 and a second rear end 836 at two opposite ends thereof respectively, and the second front end 835 of the second front supporting rod 832 is inserted into the second opening of the second insulating rod 70, so that the second front supporting rod 832 is connected to the second insulating rod 70 near the closed end 21. Furthermore, in this embodiment, the front hook 84 forms a b-shaped profile and has a first surrounding portion 841, a first ring portion 842, and a first extension portion 843 connected between the first surrounding portion 841 and the first ring portion 842, and the first surrounding portion 841 of one of the front hooks 84 is wrapped around the first rear end 834 of the first front supporting rod 831, so that the front hook 84 and the second insulating rod 70 are respectively disposed at two opposite ends of the first front supporting rod 831, and thus the first front supporting rod 831 in this embodiment can only be connected to a single one of the front hooks 84. Moreover, the first surrounding portion 841 of another one of the front hooks 84 is wrapped around the second rear end 836 of the second front supporting rod 832, so that the front hook 84 and the second insulating rod 70 are respectively disposed at two opposite ends of the second front supporting rod 832, and thus the second front supporting rod 832 in this embodiment can only be connected to a single one of the front hooks 84. At the same time, the first ring portion 842 can be provided for insertion of the spiral filament 50, so that the first ring portion 842 is encircled around the spiral filament 50, and in turn the front hooks 84 are respectively connected between the spiral filament 50 and one of the front supporting rods 83, so that the front hook 84 and the first conductive member 30 are respectively located on two opposite sides of the spiral filament 50.

Continually referring to FIG. 1, in the first preferred embodiment, the rear supporting portion 82 includes a plurality of rear supporting rods 85 and a plurality of rear hooks 86, where the rear supporting rods 85 have a first rear supporting rod 851 and a second rear supporting rod 852 parallel to the first rear supporting rod 851, the first rear supporting rod 851 has a third front end 853 and a third rear end 854 at two opposite ends thereof respectively, and the third rear end 854 of the first rear supporting rod 851 is inserted into the first opening of the first insulating rod 60, so that the first rear supporting rod 851 is connected to the first insulating rod 60 adjacent to the open end 22. However, the second rear supporting rod 852 has a fourth front end 855 and a fourth rear end 856 at two opposite ends thereof respectively, and the fourth rear end 856 of the second rear supporting rod 852 is inserted into the first opening of the first insulating rod 60, so that the second rear supporting rod 852 is connected to the first insulating rod 60 adjacent to the open end 22. Furthermore, the rear hook 86 forms a b-shaped profile and has a second surrounding portion 861, a second ring portion 862 and a second extension portion 863 connected between the second surrounding portion 861 and the second ring portion 862, and the second surrounding portion 861 of one of the rear hooks 86 is wrapped around the third front end 853 of the first rear supporting rod 851, so that the rear hook 86 and the first insulating rod 60 are respectively arranged at two opposite ends of the first rear supporting rod 851, and in turn the first rear supporting rod 851 in this embodiment can only be connected to a single one of the rear hooks 86. Furthermore, the second surrounding portion 861 of another one of the rear hooks 86 is wrapped around the fourth front end 855 of the second rear supporting rod 852, so that the rear hook 86 and the first insulating rod 60 are respectively disposed at two opposite ends of the second rear supporting rod 852, and in turn the second rear supporting rod 852 in this embodiment can only be connected to a single one of the rear hooks 86. At the same time, the second ring portion 862 can be provided for insertion of the spiral filament 50, so that the second ring portion 862 is encircled around the spiral filament 50, and in turn the rear hooks 86 are respectively connected between the spiral filament 50 and one of the rear supporting rods 85, and thus the rear hook 86 and the first conductive member 30 are respectively located on two opposite sides of the spiral filament 50. Furthermore, in this embodiment, the front supporting rods 83 have the first front supporting rod 831 and the second front supporting rod 832, and the rear supporting rods 85 have the first rear supporting rod 851 and the second rear supporting rod 852, so that the amount of the front supporting rods 83 are the same that of the rear supporting rods 85, the amount of the front hooks 84 are the same that of the rear hooks 86, and the mounting direction of the front hooks 84 is opposite to that of the rear hooks 86, so that the front supporting portion 81 and the rear supporting portion 82 are arranged to form a symmetrical pattern. Thereby, the supporting mechanism 80 is arranged between the first insulating rod 60 and the second insulating rod 70, and meanwhile the supporting mechanism 80 and the first conductive member 30 are respectively located on two opposite sides of the spiral filament 50. Furthermore, there is no restriction on the structural pattern of the front hook 84 and the rear hook 86, and the structural pattern of the front hook 84 and the rear hook 86 can be any structural pattern.

Referring to FIG. 1, in the first preferred embodiment, the fixing member 90 has a through hole. The through hole is provided for entering of the first conductive member 30 and the second insulating rod 70, and the fixing member 90 connects the first conductive member 30 and the second insulating rod 70, thus the fixing member 90 is adjacent to the closed end 21, and in turn the fixing member 90 and the supporting mechanism 80 are respectively located on two opposite sides of the spiral filament 50. Furthermore, there is no limitation on the composition material and structural pattern of the fixing member 90. The composition material of the fixing member 90 can be quartz, and the structural pattern of the fixing member 90 can be any structural pattern.

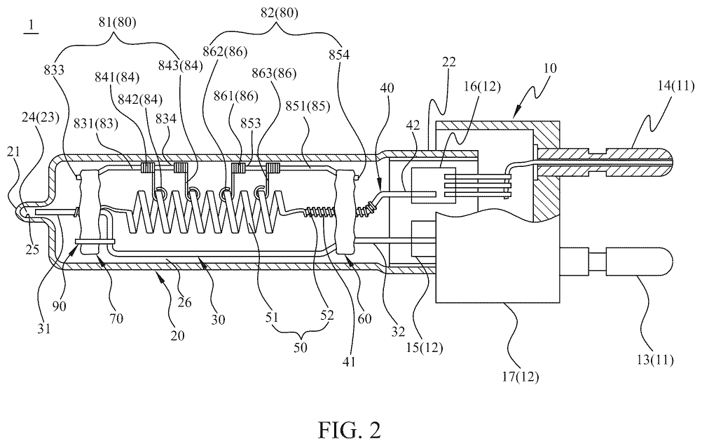

Referring to FIG. 2, in a second preferred embodiment, it differs from the first preferred embodiment in the structural pattern of the supporting mechanism 80, and the structural patterns of the eight ones, namely the socket 10, the transparent shell 20, the first conductive member 30, the second conductive member 40, the spiral filament 50, the first insulating rod 60, the second insulating rod 70 and the fixing member 90 are the same as those of the first preferred embodiment. Thus, in this embodiment the structural patterns of the eight ones, namely the socket 10, the transparent shell 20, the first conductive member 30, the second conductive member 40, the spiral filament 50, the first insulating rod 60, the second insulating rod 70 and the fixing member 90 will not be described repeatedly any more. In this embodiment, the supporting mechanism 80 includes the front supporting portion 81 and the rear supporting portion 82. The front supporting portion 81 includes the first front supporting rod 831 of the front supporting rod 83 and the front hooks 84 connected between the front supporting rod 83 and the spiral filament 50, and the rear supporting portion 82 includes the first rear supporting rod 851 of the rear supporting rod 85 and the rear hooks 86 connected between the rear supporting rod 85 and the spiral filament 50, where in this embodiment, the first surrounding portion 841 of one of the front hooks 84 is wrapped around the first rear end 834 of the first front supporting rod 831, so that one of the front hooks 84 is positioned at an end of the front supporting rod 83 and another one of the front hooks 84 is positioned between the end of the front supporting rod 83 and the second insulating rod 70, and in turn the front supporting rod 83 can connect the of the front hooks 84. Furthermore, the second surrounding portion 861 of one of the rear hooks 86 is wrapped around the third front end 853 of the first rear supporting rod 851, so that one of the rear hooks 86 is positioned at an end of the rear supporting rod 85 and another one of the rear hooks 86 is positioned between the end of the rear supporting rod 85 and the first insulating rod 60, and in turn the rear supporting rod 85 can connect the of the rear hooks 86. Thereby, in this embodiment, the amount of the front supporting rods 83 are the same that of the rear supporting rod 85, the amount of the front hooks 84 are the same that of the rear hooks 86, and the mounting direction of the front hooks 84 is opposite to that of the rear hooks 86, so that the front supporting portion 81 and the rear supporting portion 82 are arranged to form a symmetrical pattern. Thus, the supporting mechanism 80 is disposed between the first insulating rod 60 and the second insulating rod 70, and meanwhile the supporting mechanism 80 and the first conductive member 30 are respectively located on two opposite sides of the spiral filament 50. Furthermore, there is no limit to the amount of the front hooks 84 that can be connected to the front supporting rod 83 and the amount of the rear hooks 86 that can be connected to the rear supporting rod 85. The numbers of the front hooks 84 and the rear hooks 86 can be two, three, five, etc.

What is claimed is:

1. A halogen lamp, comprising:
a socket having a plug-in end and a fixed end, the fixed end including a first conductive plate, a second conductive plate and a mounting portion;
a transparent shell having a closed end and an open end, the closed end being provided with a connecting portion, and the open end being connected to the mounting portion of the socket, so that an enclosed space is formed between the closed end and the fixed end of the socket;
a first conductive member being connected between the connecting portion and the first conductive plate;
a second conductive member being connected on the second conductive plate;
a spiral filament having a spiral section and two lead sections located at two opposite sides of the spiral section, one of the lead sections being connected to the first conductive member, and the other one of the lead sections being connected to the second conductive member;
a first insulating rod being connected to the first conductive member and the second conductive member, and the first insulating rod is far away from the closed end;
a second insulating rod being connected to the first conductive member, and the second insulating rod is adjacent to the closed end; and
a supporting mechanism being disposed between the first insulating rod and the second insulating rod, the supporting mechanism and the first conductive member are respectively located on two opposite sides of the spiral filament, the supporting mechanism includes a front supporting portion and a rear supporting portion, the front supporting portion includes a plurality of front supporting rods and a plurality of front hooks, the front supporting rods are inserted into the second insulating rod, the front hooks are respectively connected between the spiral filament and one of the front supporting rods, the rear supporting portion includes a plurality of rear supporting rods and a plurality of rear hooks, the rear supporting rods are inserted into the first insulating rod, and the rear hooks are respectively connected between the spiral filament and one of the rear supporting rods;
wherein the amount of the front supporting rods are the same that of the rear supporting rods, the amount of the front hooks are the same that of the rear hooks, and the mounting direction of the front hooks is opposite to that of the rear hooks, so that the front supporting portion and the rear supporting portion are arranged to form a symmetrical pattern.

2. The halogen lamp according to claim 1, wherein the halogen lamp further has a fixing member connected the first conductive member and the second insulating rod, and the fixing member and the supporting mechanism are respectively located on two opposite sides of the spiral filament.

3. The halogen lamp according to claim 1, wherein the connecting portion is configured as a groove, and a first end of the first conductive member passes through the second insulating rod to connect the groove, and a second end of the first conductive member passes through the first insulating rod to connect the first conductive plate, so that the first conductive member is fixed between the groove and the first conductive plate.

4. The halogen lamp according to claim 1, wherein the front hook has a first surrounding portion, a first ring portion, and a first extension portion connected between the first surrounding portion and the first ring portion, and the first surrounding portion is coiled around the front supporting rod, and the first ring portion is encircled around the spiral filament, so that the front hook and the first conductive member are respectively located on two opposite sides of the spiral filament.

5. The halogen lamp according to claim 1, wherein the rear hook has a second surrounding portion, a second ring portion, and a second extension portion connected between the second surrounding portion and the second ring portion, the second surrounding portion is coiled around the rear supporting rod, and the second ring portion is encircled around the spiral filament, so that the rear hook and the first conductive member are respectively located on two opposite sides of the spiral filament.

6. A halogen lamp, comprising:
a socket having a plug-in end and a fixed end, the fixed end including a first conductive plate, a second conductive plate and a mounting portion;
a transparent shell having a closed end and an open end, the closed end being provided with a connecting portion, and the open end being connected to the mounting portion of the socket, so that an enclosed space is formed between the closed end and the fixed end of the socket;
a first conductive member being connected between the connecting portion and the first conductive plate;
a second conductive member being connected on the second conductive plate;
a spiral filament having a spiral section and two lead sections located at two opposite sides of the spiral section, one of the lead sections being connected to the first conductive member, and the other one of the lead sections being connected to the second conductive member;
a first insulating rod being connected to the first conductive member and the second conductive member, and the first insulating rod is far away from the closed end;
a second insulating rod being connected to the first conductive member, and the second insulating rod is adjacent to the closed end; and
a supporting mechanism being disposed between the first insulating rod and the second insulating rod, the supporting mechanism and the first conductive member are respectively located at two opposite sides of the spiral filament, the supporting mechanism includes a front supporting portion and a rear supporting portion, the front supporting portion includes a front supporting rod and a plurality of front hooks connected between the front supporting rod and the spiral filament, the front supporting rod is inserted into the second insulating rod, the rear supporting portion comprises a rear supporting rod and a plurality of rear hooks connected between the rear supporting rod and the spiral filament, and the rear supporting rod is inserted into the first insulating rod;
wherein the amount of the front hooks are the same that of the rear hooks, and the mounting direction of the front hooks is opposite to that of the rear hooks, so that the front supporting portion and the rear supporting portion are arranged to form a symmetrical pattern.

7. A halogen lamp, comprising:
a socket having a plug-in end and a fixed end, the fixed end including a first conductive plate, a second conductive plate and a mounting portion;
a transparent shell having a closed end and an open end, the closed end being provided with a connecting portion, and the open end being connected to the mounting portion of the socket, so that an enclosed space is formed between the closed end and the fixed end of the socket;
a first conductive member being connected between the connecting portion and the first conductive plate;
a second conductive member being connected on the second conductive plate;
a spiral filament having a spiral section and two lead sections located at two opposite sides of the spiral section, one of the lead sections being connected to the first conductive member, and the other one of the lead sections being connected to the second conductive member;
a first insulating rod being connected to the first conductive member and the second conductive member, and the first insulating rod is away from the closed end;
a second insulating rod being connected to the first conductive member, and the second insulating rod is adjacent to the closed end;
a supporting mechanism being disposed between the first insulating rod and the second insulating rod, the supporting mechanism and the first conductive member are respectively located on two opposite sides of the spiral filament, the supporting mechanism includes a front supporting portion and a rear supporting portion, the front supporting portion includes a plurality of front supporting rods and a plurality of front hooks, the front supporting rods are inserted into the second insulating rod, the front hooks are respectively connected between the spiral filament and one of the front supporting rods, the rear supporting portion includes a plurality of rear supporting rods and a plurality of rear hooks, the rear supporting rods are inserted into the first insulating rod, and the rear hooks are respectively connected between the spiral filament and one of the rear supporting rods; and
a fixing member being connected between the first conductive member and the second insulating rod, so that the fixing member and the supporting mechanism are respectively located on two opposite sides of the spiral filament;
wherein the amount of the front supporting rods are the same that of the rear supporting rods, the amount of the front hooks are the same that of the rear hooks, and the mounting direction of the front hooks is opposite to that of the rear hooks, so that the front supporting portion and the rear supporting portion are arranged to form a symmetrical pattern.
